(19) United States
(12) Patent Application Publication
(10) Pub. No.: US 2008/0103679 A1
(43) Pub. Date: May 1, 2008

(54) ACCESSORY DRIVE SYSTEM

(76) Inventor: VICTORIANO RUIZ, Brighton, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/552,761

(22) Filed: Oct. 25, 2006

(51) Int. Cl. G06F 17/00; F02B 63/00; F02B 67/06

(52) U.S. Cl. 701/106; 123/2; 123/198 R

(57) ABSTRACT

The present invention provides an accessory drive system for a vehicle. The vehicle includes a plurality of accessories, and a primary internal combustion engine adapted to drive the vehicle. The accessory drive system includes an auxiliary internal combustion engine operatively connected to each of the plurality of accessories. The auxiliary internal combustion engine is the exclusive source of power for the accessories and is configured to meet the power requirements of the accessories in a fuel efficient manner.

### TECHNICAL FIELD

The present invention pertains generally to an accessory drive system.

### BACKGROUND OF THE INVENTION

Driven accessories in a vehicle may include, for example, an air conditioning compressor, a power steering pump, and an alternator. These accessories are generally powered by output from the engine. The operating speeds of the accessories in such a conventional drive system are directly proportional to the speed of the engine. Since the engine operates over a wide speed range (i.e., for example, between 500 rpm and 7,000 rpm), the accessories are typically designed to provide full capacity at the low end of the engine speed range in order to ensure that they remain operational. Therefore, at higher engine speeds, excess energy transferred to the accessories may be lost.

### SUMMARY OF THE INVENTION

The present invention provides an accessory drive system for a vehicle. The vehicle includes a plurality of accessories, and a primary internal combustion engine adapted to drive the vehicle. The accessory drive system includes an auxiliary internal combustion engine operatively connected to each of the plurality of accessories. The auxiliary internal combustion engine is the exclusive source of power for the accessories and is configured to meet the power requirements of the accessories in a fuel efficient manner.

The accessory drive system may also include a belt operatively connecting the auxiliary internal combustion engine to the accessories.

The accessory drive system may also include a plurality of gear members operatively connecting the auxiliary internal combustion engine to the accessories.

The vehicle may include a single fuel supply operatively connected to the primary internal combustion engine and the auxiliary internal combustion engine. Alternatively, the vehicle may include a primary fuel supply operatively connected to the primary internal combustion engine; and an auxiliary fuel supply operatively connected to the auxiliary internal combustion engine.

The vehicle may include an exhaust system operatively connected to the primary internal combustion engine and the auxiliary internal combustion engine.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic depiction of a vehicle having an accessory drive system in accordance with the present invention.

### DESCRIPTION OF THE PREFERRED EMBODIMENTS

Conventional accessory drive systems operate by transferring engine output to the accessories so the accessories are driven at a speed directly proportional to engine speed. Since the engine operates over a wide speed range (e.g., between 500 rpm and 7,000 rpm), the accessories are typically designed to provide full capacity at the low end of the engine speed range in order to ensure they remain fully operational. Therefore, when the engine is operating at higher speeds, conventional accessory drive systems transfer more energy to the accessories than necessary to provide adequate function. Additionally, accessory drive systems powered exclusively by the engine are not ideally applied to hybrid vehicles wherein the engine is periodically shut off in order to conserve fuel.

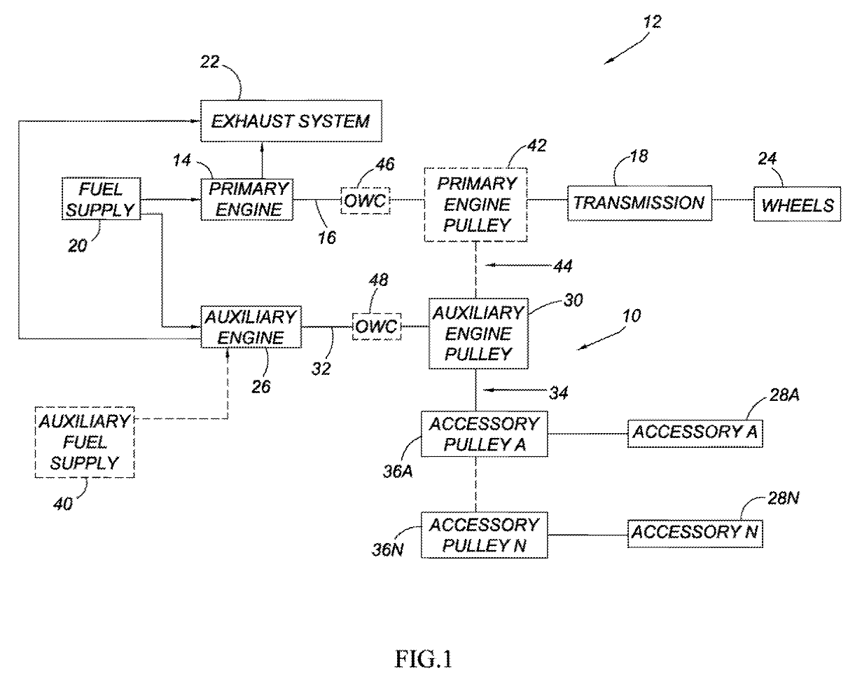

Referring to FIG. 1, a schematic representation of an accessory drive system 10 for a hybrid vehicle 12 is shown. While the accessory drive system 10 is described as being applied to a hybrid vehicle in accordance with the preferred embodiment of the present invention, the accessory drive system 10 may also be applied to other types of vehicles. The hybrid vehicle 12 includes a primary engine 14 configured to transmit output via the crankshaft 16 to a transmission 18. The primary engine 14 is preferably an internal combustion engine which receives fuel from a fuel supply 20 and expels exhaust gases through an exhaust system 22. The transmission 18 transfers output from the primary engine 14 to a plurality of wheels 24 in order to drive the hybrid vehicle 12.

The accessory drive system 10 includes an auxiliary engine 26 configured to power a plurality of accessories 28A-28N, which may include, for example, an air conditioning compressor, a power steering pump, and an alternator. The auxiliary engine 26 is preferably selected to match the power requirements of the accessories 28A-28N in an optimally efficient manner. In other words, a smaller auxiliary engine is implemented in applications with light accessory loads and a larger auxiliary engine is implemented in applications with heavy accessory loads. As the size of the auxiliary engine 26 is selected to minimize the transfer of excess energy to the accessories 28A-28N, accessory drive system efficiency and vehicle fuel economy are improved.

The auxiliary engine 26 transfers output to an auxiliary engine pulley 30 via the crankshaft 32. A belt 34 couples the auxiliary engine pulley 30 with a plurality of accessory pulleys 36A-36N. According to an alternate embodiment, the belt 34 and the pulleys 30, 36A-36N may be replaced by any known coupling apparatus such as, for example, a chain and a plurality of sprockets (not shown). The accessory pulleys 36A-36N are each operatively connected to an accessory 28A-28N, respectively. The rotation of the pulleys 36A-36N powers the accessories 28A-28N connected thereto. Therefore, the auxiliary engine 26 transfers torque via the crankshaft 32, through the auxiliary engine pulley 30, through the belt 34, and to the accessory pulleys 36A-36N such that the accessories 28A-28N are optimally powered and fully operational. According to an alternate embodiment, the accessories 28A-28N may be directly driven by the auxiliary engine crankshaft 32 such as, for example, with the incorporation of a first plurality of gear members (not shown) mounted directly to the crankshaft 32 and respectively engaged with a second plurality of gear members (not shown) configured to drive the accessories 28A-28N.

According to the preferred embodiment, the auxiliary engine 26 is an internal combustion engine which receives fuel from the fuel supply 20 and expels exhaust gases through the exhaust system 22. According to an alternate embodiment, the auxiliary engine 26 may be provided with an auxiliary fuel supply 40 shown with dashed lines. The auxiliary engine 26 is preferably mounted within an accessible portion of the engine compartment (not shown) of the hybrid vehicle 12. The auxiliary engine 26 is preferably mounted to the hybrid vehicle 12 with bolts (not shown) so that the auxiliary engine 26 may be easily removed for service or replaced with a new auxiliary engine.

According to the preferred embodiment described hereinabove, the accessories 28A-28N are powered exclusively by the auxiliary engine 26. According to an alternate embodiment described in detail hereinafter, the accessories 28A-28N are powered by the primary engine 14 when the engine 14 is running and the accessories 28A-28N are powered by the auxiliary engine 26 when the engine 14 is off.

According to the alternate embodiment, a primary engine pulley 42 shown with dashed lines is attached to the engine crankshaft 16. A second belt 44 couples the primary engine pulley 42 with the auxiliary engine pulley 30. Alternatively, a single belt (not shown) coupling the primary engine pulley 42, the auxiliary engine pulley 30, and the accessory pulleys 36A-36N may replace the individual belts 34 and 44. Accordingly, the primary engine 14 can transfer torque via the crankshaft 16, through the primary engine pulley 42, through the second belt 44, through the auxiliary engine pulley 30, through the belt 34, and to the accessory pulleys 36A-36N such that the accessories 28A-28N are powered. When the primary engine 14 is off such as, for example, when the hybrid vehicle 12 is being electrically driven in order to conserve fuel, the accessories 28A-28N can be powered by the auxiliary engine 24 in the manner previously described with respect to the preferred embodiment.

A one-way clutch 46 may be operatively connected to the crankshaft 16 between the primary engine 14 and the primary engine pulley 42. The one-way clutch 46 is configurable to transmit torque in a first direction (i.e., from the primary engine 14 to the primary engine pulley 42) and to interrupt the transfer of torque in a second direction (i.e., from the primary engine pulley 42 to the primary engine 14). Therefore, the one-way clutch 46 prevents the transfer of torque from the auxiliary engine 26 to the primary engine 12 such that the auxiliary engine 26 can drive the accessories 28A-28N in an efficient manner.

A one-way clutch 48 may be operatively connected to the crankshaft 32 between the auxiliary engine 26 and the auxiliary engine pulley 30. The one-way clutch 48 is configurable to transmit torque in a first direction (i.e., from the auxiliary engine 26 to the auxiliary engine pulley 30) and to interrupt the transfer of torque in a second direction (i.e., from the auxiliary engine pulley 30 to the auxiliary engine 26). Therefore, the one-way clutch 48 prevents the transfer of torque from the primary engine 12 to the auxiliary engine 26 such that the primary engine 12 can drive the accessories 28A-28N in an efficient manner.

While the best modes for carrying out the invention have been described in detail, those familiar with the art to which this invention relates will recognize various alternative designs and embodiments for practicing the invention within the scope of the appended claims.

1. A vehicle comprising:
an accessory;
a primary internal combustion engine adapted to drive the vehicle; and
an auxiliary internal combustion engine operatively connected to the accessory, said auxiliary internal combustion engine being the exclusive source of power for the accessory, wherein the auxiliary internal combustion engine is configured to meet the power requirements of the accessory in a fuel efficient manner.

2. The vehicle of claim 1, further comprising a plurality of pulleys configured to facilitate the transfer of power from the auxiliary internal combustion engine to the accessory.

3. The vehicle of claim 2, further comprising a belt operatively connecting said plurality of pulleys.

4. The vehicle of claim 1, further comprising a plurality of gear members operatively connecting the auxiliary internal combustion engine to the accessory.

5. The vehicle of claim 1, further comprising a fuel supply operatively connected to the primary internal combustion engine and the auxiliary internal combustion engine, said fuel supply adapted to transfer fuel to both the primary internal combustion engine and the auxiliary internal combustion engine.

6. The vehicle of claim 1, further comprising a primary fuel supply operatively connected to the primary internal combustion engine; and an auxiliary fuel supply operatively connected to the auxiliary internal combustion engine.

7. The vehicle of claim 1, further comprising an exhaust system operatively connected to the primary internal combustion engine and the auxiliary internal combustion engine, said exhaust system adapted to expel exhaust gasses from the primary internal combustion engine and the auxiliary internal combustion engine.

8. A hybrid vehicle comprising:
a plurality of accessories;
a primary internal combustion engine adapted to drive the hybrid vehicle;
an auxiliary internal combustion engine operatively connected to the plurality of accessories, said auxiliary internal combustion engine being the exclusive source of power for the plurality of accessories, wherein the auxiliary internal combustion engine is configured to meet the power requirements of the plurality of accessories in a fuel efficient manner;
a plurality of pulleys each operatively connected to one of said auxiliary internal combustion engine and said plurality of accessories, said plurality of pulleys configured to facilitate the transfer of power from the auxiliary internal combustion engine to the plurality of accessories; and
a belt operatively connecting said plurality of pulleys.

9. The hybrid vehicle of claim 8, further comprising a fuel supply operatively connected to the primary internal combustion engine and the auxiliary internal combustion engine, said fuel supply adapted to transfer fuel to both the primary internal combustion engine and the auxiliary internal combustion engine.

10. The hybrid vehicle of claim 8, further comprising a primary fuel supply operatively connected to the primary internal combustion engine; and an auxiliary fuel supply operatively connected to the auxiliary internal combustion engine.

11. The hybrid vehicle of claim 8, further comprising an exhaust system operatively connected to the primary internal combustion engine and the auxiliary internal combustion engine, said exhaust system adapted to expel exhaust gasses from the primary internal combustion engine and the auxiliary internal combustion engine.

12. An accessory drive system for a hybrid vehicle comprising:
an accessory;
a primary internal combustion engine; and
an auxiliary internal combustion engine operatively connected to the accessory;
wherein the accessory is exclusively powered by the auxiliary internal combustion engine when the hybrid vehicle is driven by said primary internal combustion engine and when the hybrid vehicle is being electrically driven.

13. The accessory drive system of claim 12, further comprising a belt operatively connecting the auxiliary internal combustion engine to the accessory.

14. The accessory drive system of claim 12, further comprising a belt operatively connecting the auxiliary internal combustion engine to the accessory.

15. The accessory drive system of claim 12, further comprising a plurality of gear members operatively connecting the auxiliary internal combustion engine to the accessory.

16. The accessory drive system of claim 12, further comprising a fuel supply operatively connected to the primary internal combustion engine and the auxiliary internal combustion engine, said fuel supply adapted to transfer fuel to both the primary internal combustion engine and the auxiliary internal combustion engine.

17. The accessory drive system of claim 12, further comprising a primary fuel supply operatively connected to the primary internal combustion engine; and an auxiliary fuel supply operatively connected to the auxiliary internal combustion engine.

18. The accessory drive system of claim 12, further comprising an exhaust system operatively connected to the primary internal combustion engine and the auxiliary internal combustion engine, said exhaust system adapted to expel exhaust gasses from the primary internal combustion engine and the auxiliary internal combustion engine.

19. (canceled)
